(19) United States
(12) Patent Application Publication
(10) Pub. No.: US 2012/0299763 A1
(43) Pub. Date: Nov. 29, 2012

(54) POSITION DETERMINING METHOD AND SYSTEM USING SURVEILLANCE GROUND STATIONS

(75) Inventors: Dean E. Ryan, Dublin, OH (US); Daniel J. Schwinn, Melbourne Beach, FL (US); Edward A. Lester, Somerville, MA (US)

(73) Assignee: AVIDYNE CORPORATION, Lincoln, MA (US)

(21) Appl. No.: 13/455,088

(22) Filed: Apr. 24, 2012

Related U.S. Application Data
(60) Provisional application No. 61/491,031, filed on May 27, 2011.

(51) Int. Cl. G01S 13/91

(52) U.S. Cl. 342/37

(57) ABSTRACT

An aircraft avionics system and method for automatically determining an aircraft position. The system and method determine distances to UAT ground stations based on timing signals in transmissions from the UAT ground stations and determines one or more possible positions for the aircraft at which the aircraft is at the determined distances from respective UAT ground stations. The system and method may use three or more UAT ground stations to reduce the possible positions for the aircraft to a single possible position. The system and method also may use dead reckoning or VOR or ADF signals to reduce the possible positions for the aircraft to a single possible position. The system and method may also determine the position of an aircraft by determining true bearings to SSR ground stations and determining the possible positions for the aircraft at which the aircraft is at respective bearings to each SSR ground station.

### RELATED APPLICATION(S)

This application claims the benefit of U.S. Provisional Application No. 61/491,031, filed on May 27, 2011. The entire teachings of the above application(s) are incorporated herein by reference.

### BACKGROUND OF THE INVENTION

Many aircraft are going to be equipping with surveillance equipment as part of the FAA Automatic Dependent Surveillance-Broadcast (ADS-B) mandate. An ADS-B-equipped aircraft determines its own position and periodically broadcasts its determined latitude and longitude position (and other information) to ground stations and other ADS-B-equipped aircraft. Typically, the ADS-B-equipped aircraft determines its position using a Global Navigation Satellite System (GNSS) receiver like a Global Positioning System (GPS) receiver, which determines a position in three dimensions latitude, longitude, and altitude.

### SUMMARY OF THE INVENTION

There is a market demand for a backup position determining source when there is a GNSS outage or the GNSS system is otherwise unavailable.

Embodiments of the present invention provide electronic or computer-based avionics systems. The invention system determines a subject aircraft's position by receiving timing signals from two or more Universal Access Transceiver (UAT) ground stations. The timing signals are compared to an onboard timing signal to determine distances from each UAT ground station. The system then determines one or more possible positions at which the aircraft is located at the respective distances from each UAT ground station. The system may use determined distance to a third UAT ground station to reduce the possible positions to a single position. The system may use determined distance to additional UAT ground stations to further refine the position determination. The aircraft also may use dead reckoning or a VOR or ADF signal to reduce the possible positions to a single position. The invention system may output the determined position to an ADS-B system.

In other embodiments of the invention system, the system determines the position of a subject aircraft by determining relative bearings to Secondary Surveillance Radar (SSR) ground stations. Once the relative bearings to the SSR ground stations are known and the position of the SSR ground stations are determined from a database, the position of the aircraft relative to the SSR ground stations can be determined. The system may use the relative bearing to a third SSR ground station to reduce the possible positions to a single position. The system may use relative bearing to additional SSR ground stations to further refine the position determination. The aircraft also may use dead reckoning or a VOR or ADF signal to reduce the possible positions to a single position. The invention system may output the determined position to an ADS-B system.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a plan view of two possible positions of a subject aircraft at which the aircraft is a first distance from a first UAT ground station and a second distance from a second UAT ground station.

FIG. 2 is a plan view of a single one of the two possible positions of the subject aircraft of FIG. 1 at which the aircraft is a first distance from a first UAT ground station, a second distance from a second UAT ground station, and a third distance from a third UAT ground station.

FIG. 3 is a schematic diagram of an embodiment of the invention system.

FIG. 4A is a side view of a subject aircraft at an altitude equal to the elevation of a UAT ground station.

FIG. 4B is a side view of a subject aircraft at an altitude higher than the elevation of a UAT ground station.

FIG. 5 is a plan view of a possible position of a subject aircraft at which a first SSR ground station is at a first bearing off the aircraft heading and a second SSR ground station is at a second bearing off the aircraft heading.

FIG. 6 is a schematic view of the triangular dimensions and angles used to determine a subject aircraft's position based on bearings to two SSR ground stations when the two SSR ground stations are in a line that is parallel to the aircraft heading.

FIG. 7 is a schematic view of the triangular dimensions and angles used to determine a subject aircraft's position based on bearings to two SSR ground stations when the two SSR ground stations are in a line that is not parallel to the aircraft heading.

FIG. 8A is a schematic view of an embodiment of the invention system.

FIG. 8B is a flow diagram of avionics subsystem or module in the embodiment of FIG. 8A.

FIGS. 9-13 illustrate an example of the present invention determining aircraft position without knowing the aircraft heading.

FIG. 14 is a schematic illustration of the present invention determining aircraft true heading for the example of FIGS. 9-13.

### DETAILED DESCRIPTION OF THE INVENTION

A description of example embodiments of the invention follows.

Embodiments of the invention system use Universal Access Transceiver (UAT) ground stations broadcasting at 978 MHz and/or Secondary Surveillance RADAR(SSR) ground stations broadcasting at 1030 MHz to determine aircraft position.

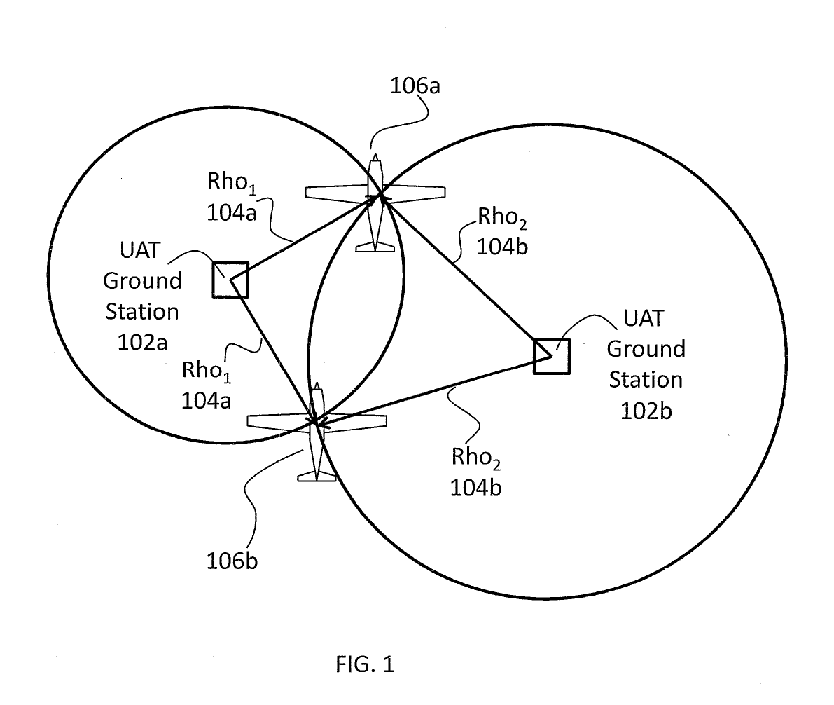

FIG. 1 shows a top-down view of two UAT ground stations 102a,b. An aircraft 106a,b is flying between the two UAT ground stations 102a,b. The aircraft 106a, b is capable of transmitting data to and receiving data from the UAT ground stations 102a,b. The signals received from the UAT ground stations 102a,b include a timing signal that is synchronized with a reference time signal. By comparing the timing signals from the UAT ground stations 102a,b with an internal clock, the aircraft 106a,b is capable of determining a distance rho₁ 104a from the aircraft 106a,b to ground station 102a and a distance rho₂ 104b from the aircraft 16a,b to ground station 102b. Distances rho₁ 104a and rho₂ 104b are relative radial distances from UAT ground stations 102a,b, respectively. As shown in FIG. 1, there are two possible relative locations for the aircraft 106a,b—a first relative location 106a and a second relative location 106b—at which a particular combination of rho₁ 104a and rho₂ 104b can simultaneously occur.

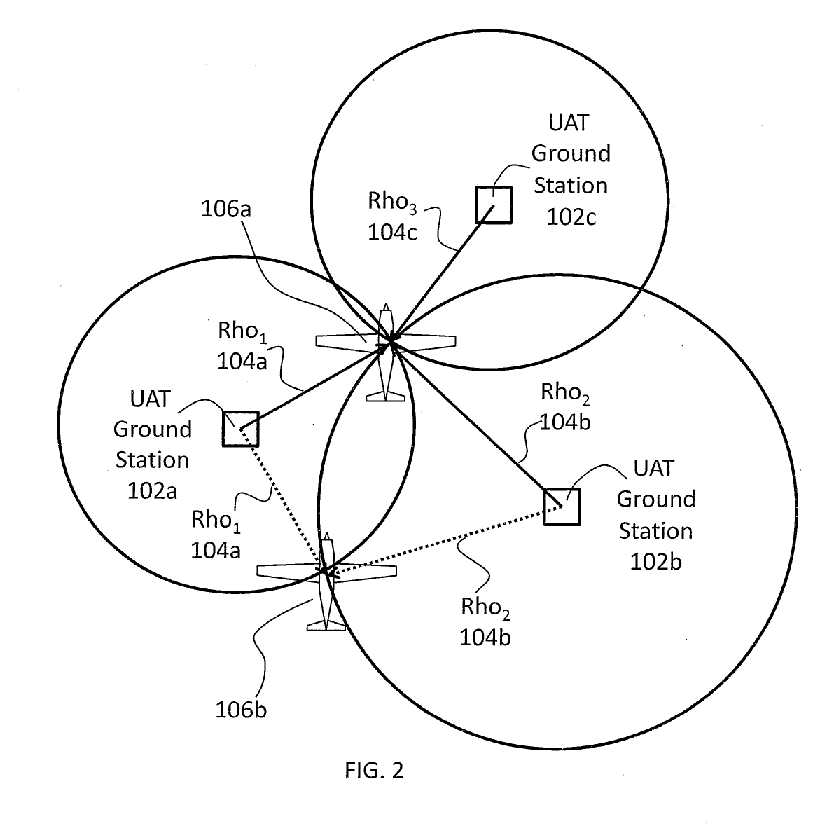

FIG. 2 illustrates one possible method for determining whether the aircraft is located at the first relative location 106a or the second relative location 106b. FIG. 2 shows a third UAT ground station 102c being communicated with the aircraft 106a,b. In so doing, the aircraft 106a,b is capable of determining a radial distance rho₃ 104c from the aircraft 106a,b to the third UAT ground station 102c. There is only one aircraft location 106a at which a particular combination of rho₁, rho₂, and rho₃ can simultaneously occur. Other methods for determining whether the aircraft is located at the first location 106a or the second location 106b, such as dead reckoning, may be used. For example, aircraft airspeed and heading can be integrated over time, i.e., dead reckoning, to determine an estimated position. This estimated position can be compared with locations 106a,b to determine the more probable location of the aircraft. A third method for resolving the ambiguity between locations 106a,b is to use data from ground-based navigation aids such as VOR or ADF.

As described above, the determined location 106a is a relative location, which only describes the aircraft location 106a relative to the multiple UAT ground stations 102. To determine the aircraft's actual latitude and longitude, the locations of the UAT ground stations 102a,b,c must be known. The system onboard the aircraft looks up the locations of one or more of the UAT ground stations 102 in a database, look-up table, or the like, and then determines its actual position from the retrieved latitude, longitude locations of the UAT ground stations 102. Alternatively, the UAT ground stations may broadcast their respective locations, and the system determines its actual positions from the broadcast locations of the UAT ground stations.

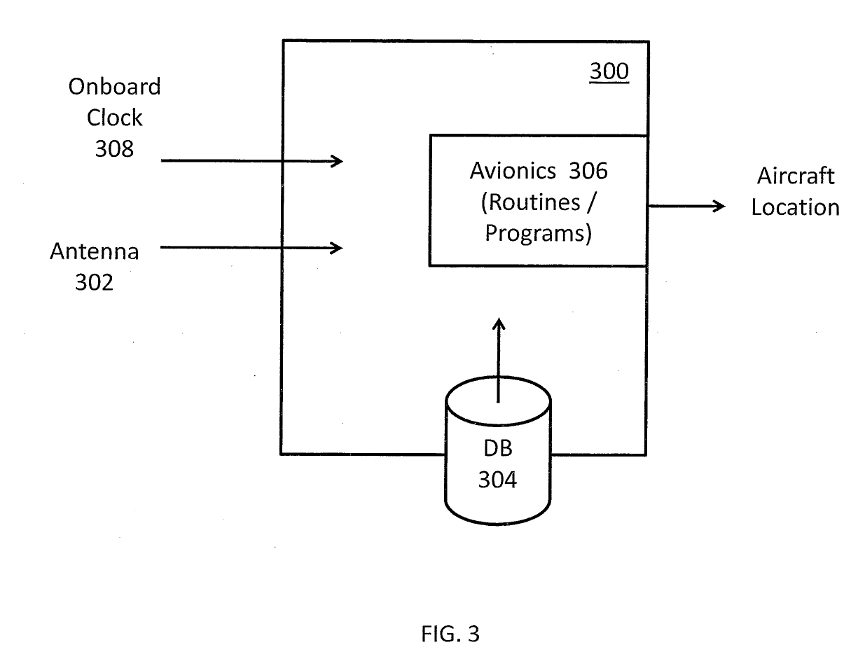

FIG. 3 shows a typical configuration for the invention system described above. The system 300 includes an antenna 302 that receives transmissions from the UAT stations 102. The antenna may be an L-band antenna, which many aircraft already are equipped with. The system includes avionics 306, which receives the UAT ground station transmissions from antenna 302. The system 300 also includes an onboard clock 308. The system 300 computes a distance from UAT ground stations 102 (not shown) by calculating a difference between the time reading of the onboard clock 308 and the UAT ground station transmissions. The system 300 also includes a database 304, which includes locations (latitude and longitude) of UAT ground stations 102. The avionics 306 extract from database 304 the locations (latitude and longitude) of the UAT ground stations 102 with which it is communicating via antenna 302 and then computers the aircraft actual location (latitude and longitude) based on the determined relative position. The UAT station location may also be broadcast by the UAT station and received by the system, eliminating the need for an onboard database.

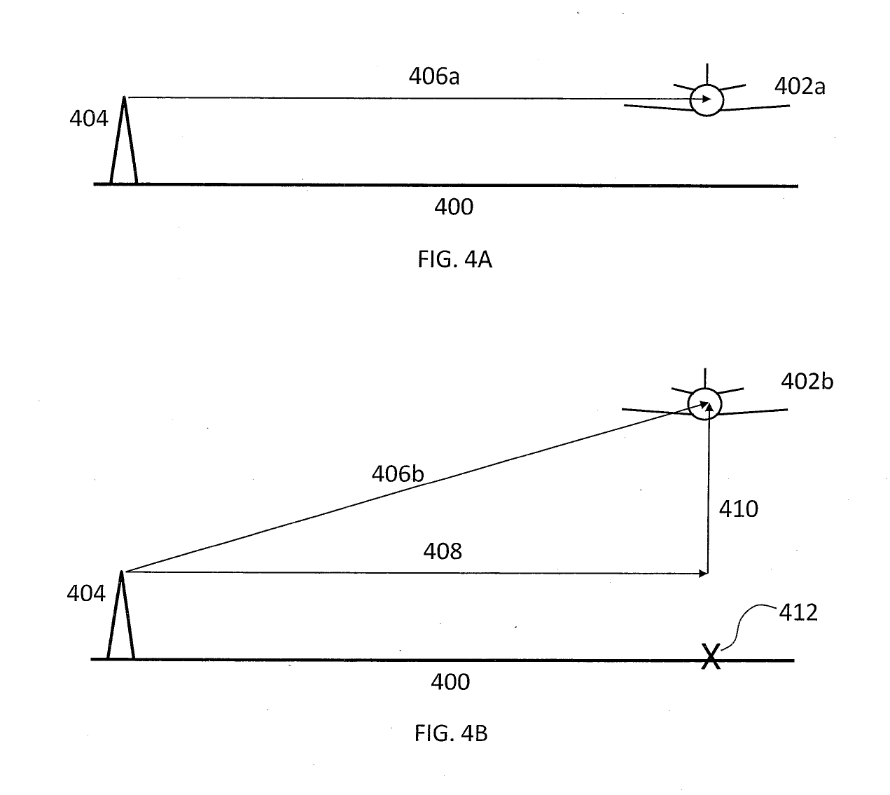

The examples in FIGS. 1 and 2 assume that the aircraft 106a,b is at an altitude that is equal to the field elevation of the UAT ground stations 102a,b. FIG. 4A shows a side view of an aircraft 402a in such an arrangement in which a distance 406a from the UAT ground station 404 to the aircraft 402a is horizontal and parallel to the ground 400. Most likely, however, as shown in FIG. 4B, the aircraft 402b will be at some altitude 410 above the field elevation of the UAT ground station 404. Therefore, the distance 406b is the hypotenuse of a right triangle in which a horizontal distance 408 from the UAT ground station 404 to the aircraft 402b present latitude/longitude position 412 and a vertical distance 410 form the remaining two sides of the triangle. When the aircraft is far away from the UAT ground stations 404, the vertical distance 410 has a negligible effect on the distance 406a. However, closer to the UAT ground station 404, the vertical distance 410 is significant and must be accounted for. The hypotenuse distance 406b is calculated as described above by comparing the time signals from the UAT station 404 to the time of an onboard clock 308. The vertical distance 410 is the difference between the altitude of the aircraft 402b and the field elevation of the UAT ground station 404 as stored in an onboard database or received from the UAT station. The vertical distance 410 can be calculated by subtracting the UAT ground station 404 field elevation (stored in database 304) and an altitude reading from the avionics 306 (e.g., from a pressure altimeter). Once the hypotenuse distance 406b and the altitude distance 410 are calculated, the horizontal distance 408 can be calculated according to the equation: a²+b²=c², where a and b are horizontal distance 408 and vertical distance 410, respectively and c is the hypotenuse vector 406b. The horizontal distance 408 is the corrected distance 412, e.g., rho₁ and rho₂, to use to calculate the position of the aircraft 402b, as described above with respect to FIGS. 1 and 2.

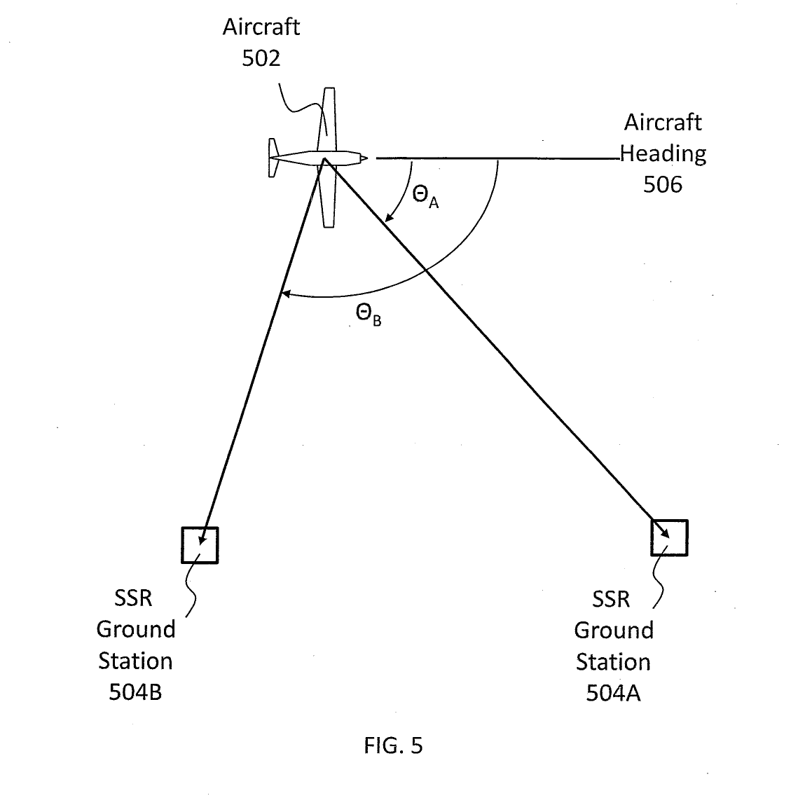

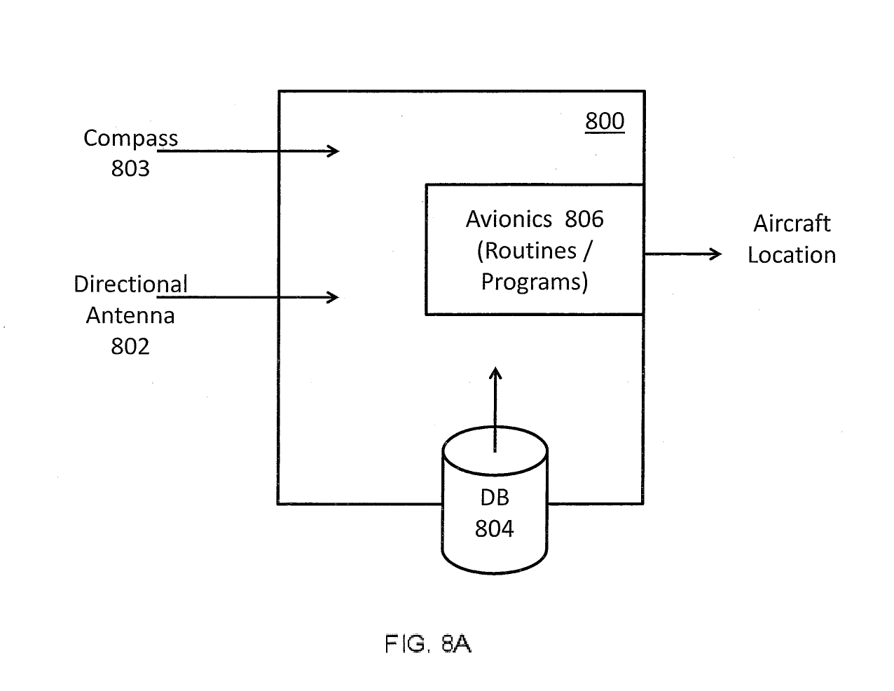

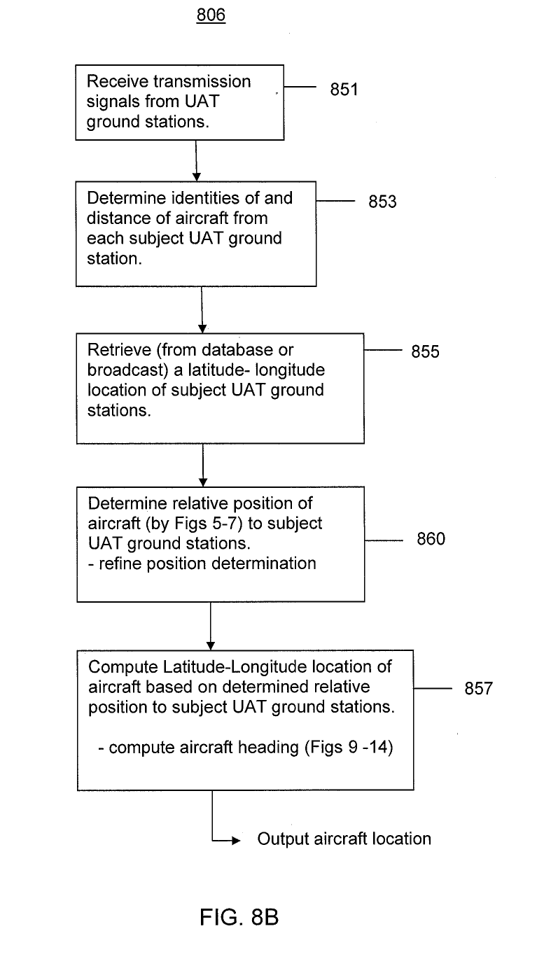

FIG. 5 shows an example of how an invention system onboard 800 (FIG. 8A) an aircraft 502 may determine its position by determining relative bearings Θ_{A} and Θ_{B} to received 1030 MHz SSR interrogations from SSR ground stations 504A,B. The aircraft 502 is able to determine bearings Θ_{A} and Θ_{B} to the SSR ground stations 504A,B using a directional antenna 802 (FIG. 8A), such as a TAS or TCAS directional antenna (not shown). The directional antenna can determine an azimuth angle Θ_{A} to a first SSR ground station 504A relative to the aircraft heading 506. The directional antenna 802 also can determine an azimuth angle Θ_{B} to a second SSR ground station 504B relative to the aircraft heading 506. The system 800 can determined the position of aircraft 502 once azimuth angles Θ_{A} and Θ_{B} are determined. Azimuth angles Θ_{A} and Θ_{B} can be converted from bearings relative to the aircraft heading 506 to true bearings (angle from magnetic north) by adding the aircraft heading 506, e.g., from a compass 803 heading, to the relative azimuth angles Θ_{A} and Θ_{B}.

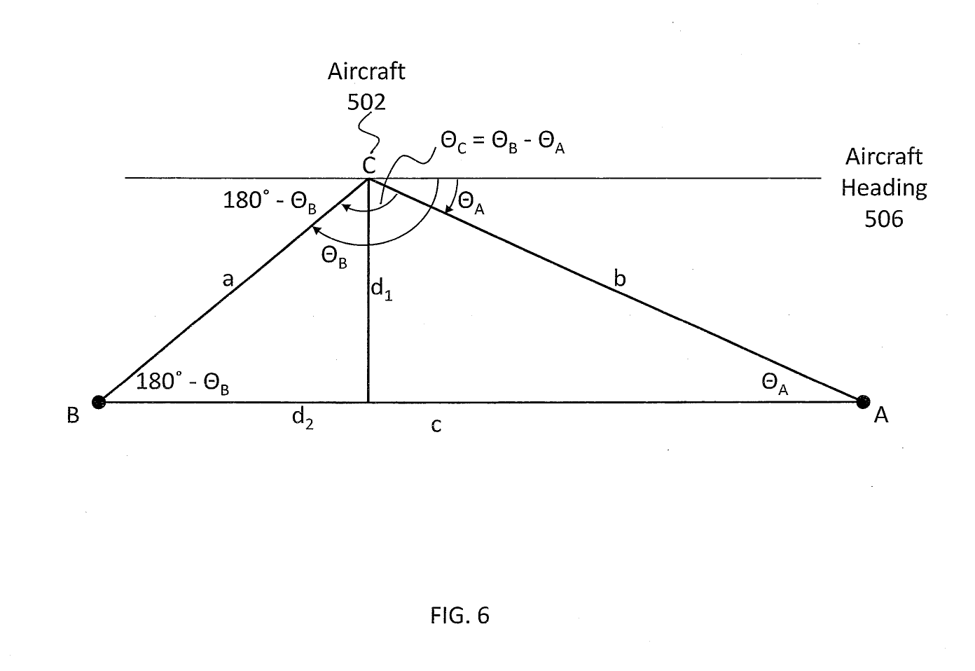

FIG. 6 shows the geometry for an aircraft C relative to two SSR ground stations A,B. As described above, angles Θₐ and Θ_{b} are known angles, determined in the aircraft 502 using a directional antenna. The identities of the SSR ground towers A,B are determined by the aircraft 502 from the SSR transmissions, and the locations (latitude/longitude) of the SSR ground stations A,B can be determined from a database of SSR ground stations. Additionally, the SSR location could be transmitted by the SSR and received by the aircraft system, eliminating the need for an onboard database. In this example, the two SSR ground stations A,B are assumed to be on a line approximately parallel to the aircraft heading 506. Because the locations of the two SSR ground stations A,B are known, the distance c between them can be determined as:

c=\sqrt{Δlatitude²+Δlongitude²}. (1)

The Δlatitude and Δlongitude are converted from degrees into feet or meters or another unit of distance prior to calculating c. Determining distance d of the aircraft relative to the ground stations relies on properties of triangles:

$$\frac{a}{sin {θ}_{A}} = \frac{b}{sin ( 180 ° - {θ}_{B} )} = \frac{c}{sin {θ}_{C}} , \qquad ( 2 )$$

which can be rearranged as

$$= \frac{c sin {θ}_{A}}{sin {θ}_{C}} ; \qquad ( 3 )$$

π=Θ_{A}+(180°−Θ_{B})+θ_{C}, (4)

which can be rearranged as

θ_{C}=π−θ_{A}−(180°−Θ_{B}); (5)

$$sin ( 180 ° - {θ}_{B} ) = \frac{{d}_{1}}{a} , \qquad ( 6 )$$

which can be rearranged as

d₁=a sin(180°−Θ_{B}). (7)

Equations (3) and (5) can be combined as

$$a = \frac{c sin {θ}_{A}}{sin ( π - {θ}_{A} - ( 180 ° - {θ}_{B} ) )} . \qquad ( 8 )$$

Equation (8) can be combined into equation (6) such that:

$${d}_{1} = \frac{c sin {θ}_{A} sin ( 180 ° - {θ}_{B} )}{sin ( π - {θ}_{A} - ( 180 ° - {θ}_{B} ) )} . \qquad ( 9 )$$

Equation (9) provides relative distance d₁ to SSR ground station B along a vector perpendicular to aircraft heading 506 using only known azimuths Θₐ,Θ_{b} to the ground stations and the known locations of the SSR ground stations A,B. A distance h₂ to SSR ground station B along a vector parallel to aircraft heading 506 can be determined according to the Pythagorean formula:

d₁²+d₂²=a². (10)

The equation can be rewritten to solve for d₂ as:

d₂=\sqrt{a²−h₁²}. (11)

By way of example, if the aircraft is heading due East, then d₁ is the distance in latitude from SSR ground station B to the aircraft and d₂ is the distance in longitude from SSR ground station B to the aircraft. As another example, if the aircraft is heading due North, then h₁ is the distance in longitude from SSR ground station B to the aircraft and h₂ is the distance in latitude from SSR ground station B to the aircraft. Again, because the location of SSR ground station B is known, the aircraft's location can be determined by applying the determined latitude and longitude distances to the known location of SSR ground station B. It should be noted that the equations above were arbitrarily solved for SSR ground station B, and they could be solved for SSR ground station A as well.

If the aircraft is not traveling either due North, South, East, or West, then distances d₁ and d₂ each include a latitude component and a longitude component. If β is the angle of the aircraft heading away from due North (0° heading), then the distance in latitude=h₁ sin β+h₂ cos β and the distance in longitude=h₁ cos β+h₂ sin β.

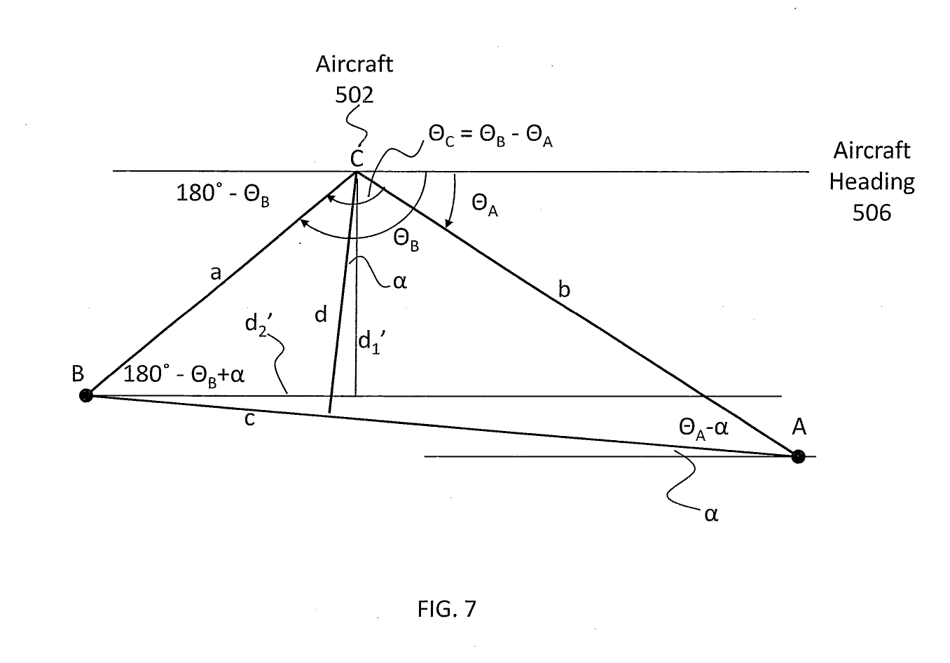

FIG. 7 addresses the more likely circumstances in which the two SSR ground stations A,B are located on a line that is not parallel to the aircraft heading 506. Because the locations of SSR ground stations A and B are known, a directional vector between the two stations can be determined. The difference between the calculated vector and the aircraft heading 506 is an angle α.

As a result of SSR ground stations A,B being on a line that is not parallel to the aircraft heading 506, triangle distance d₁ is no longer perpendicular to the aircraft heading. To determine the aircraft 502 position relative to the SSR ground stations, a distance to one of the SSR ground stations that is perpendicular to the aircraft heading 506 and a distance to the SSR ground station that is parallel to the aircraft heading 506 need to be determined. For example, distance d′₁ is a distance from the aircraft 502 to SSR ground station B that is perpendicular to the aircraft heading 506, and d′₂ is a distance from the aircraft 502 to SSR ground station B that is parallel to the aircraft heading 506.

For the circumstances in FIG. 7 in which the SSR ground stations A,B are not on a line that is parallel to the aircraft heading, equation (2) above can be modified as:

$$\frac{a}{sin ( {θ}_{A} - α )} = \frac{b}{sin ( 180 ° - {θ}_{B} + α )} = \frac{c}{sin {θ}_{C}} , \qquad ( 12 )$$

which can be rearranged as:

$$a = \frac{c sin ( {θ}_{A} - α )}{sin {θ}_{C}} . \qquad ( 13 )$$

Once a is known, then the relative distance d′₁ from ground station B to the aircraft perpendicular to the aircraft heading 506 can be determined because

$$sin ( 180 ° - {θ}_{B} ) = \frac{{d}_{1}^{′}}{a} , \qquad ( 14 )$$

which can be rearranged as:

d′₁=a sin(180°−θ_{B}). (15)

Combining equation (13) into equation (15) results in:

$${d}_{1}^{′} = \frac{c sin ( 180 ° - {θ}_{B} ) sin ( {θ}_{A} - α )}{sin {θ}_{C}} . \qquad ( 16 )$$

Then, the relative distance d′₂ from ground station B to the aircraft parallel to the aircraft heading 506 can be determined using the Pythagorean formula:

d′₁²+d′₂²=a². (17)

The equation can be rewritten to solve for d′₂ as:

d′₂=\sqrt{a²−d′₁²}. (18)

As described above, d′₁ and d′₂, corrected for aircraft heading away from due North β, provides the aircraft's 502 position relative to SSR ground station B.

FIGS. 8A and 8B show a typical configuration for the invention system described above. The system 800 includes a directional antenna 802 that receives transmissions from the SSR ground stations and a compass 803 that determines aircraft heading. The antenna may be a TAS or TCAS antenna, which many aircraft already are equipped with. The system includes avionics 806, which from the received transmissions determines the identities of at least two SSR ground stations and also determines the azimuths to the SSR ground stations (steps 851, 853 in FIG. 8B). The system 800 also includes a database 804, which includes locations (latitude and longitude) of SSR and ground stations. The avionics 806 (step 855) extract from database 804 the locations (latitude and longitude) of the SSR ground stations with which it is communicating via antenna 802 and then computes (step 857) the aircraft actual location (latitude and longitude) based on the determined relative position as calculated in FIGS. 5-7 (step 860). The SSR positions could also be received from the SSR transmissions, make the database optional. The database 304,804 of ground station identifiers and latitude/longitudes, or positions of ground stations received from transmissions from respective ground stations, is required in embodiments to make an aircraft position determination.

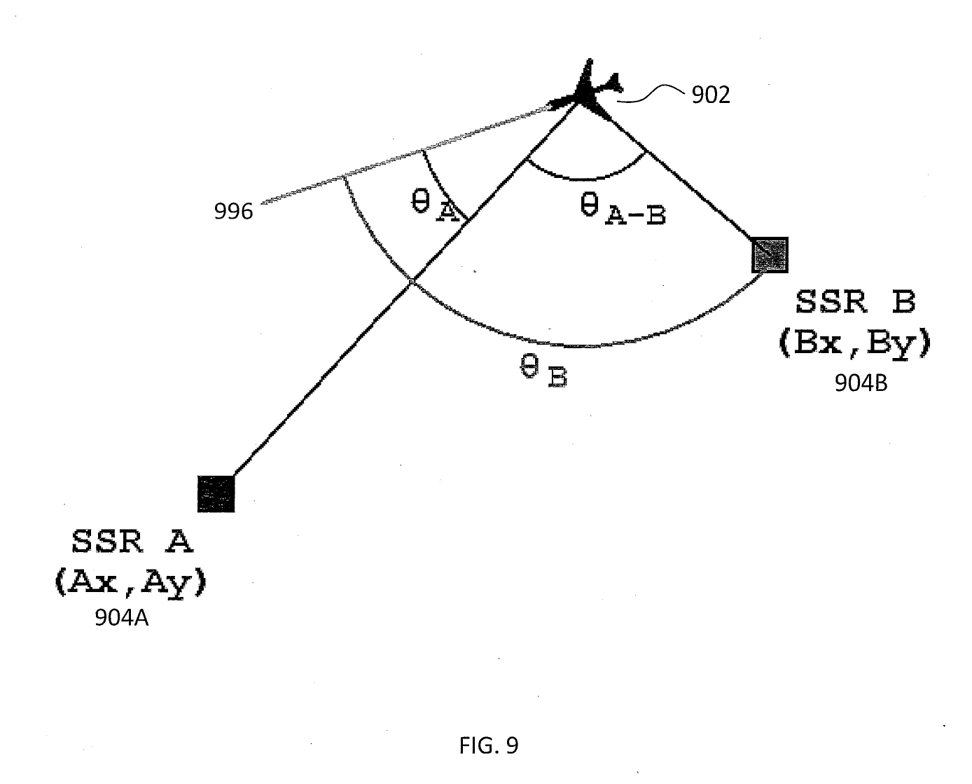

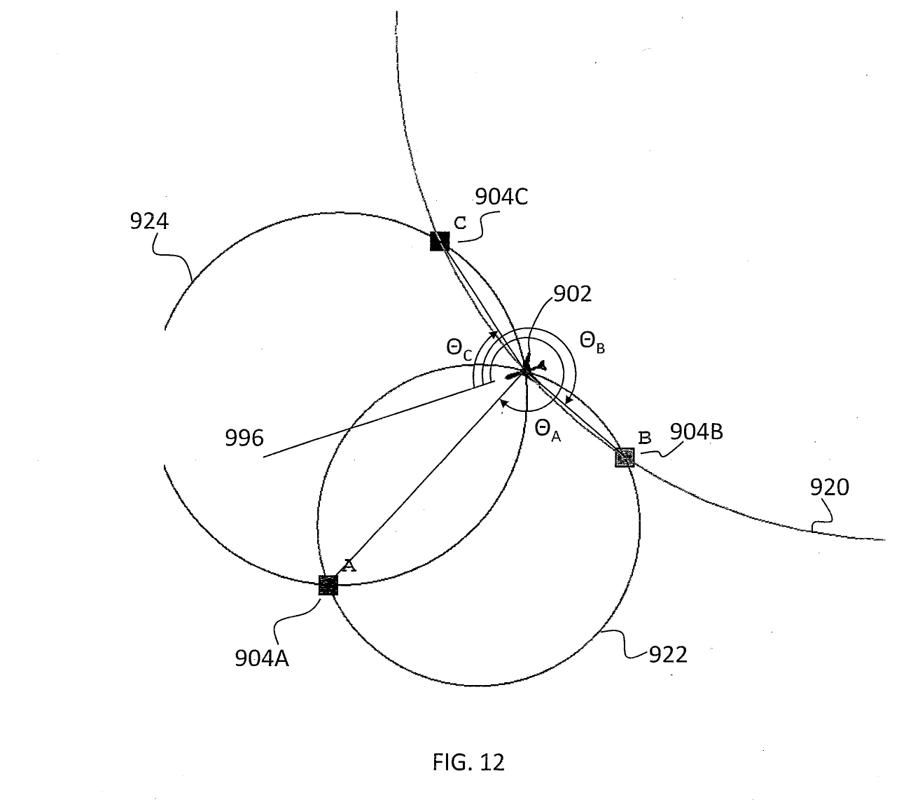

FIGS. 9-13 show an example of how an invention system onboard an aircraft 902 may determine its position by determining relative bearings Θ_{A}, Θ_{B}, and Θ_{C} to received 1030 MHz SSR interrogations from three SSR ground stations without knowing the aircraft heading 906. As shown in FIG. 12, the invention system determines the centers and radii of three circles, each circle including the aircraft and a different combination of two of the three SSR ground stations. For example, a first circle has a circumference 920, which includes the aircraft 902 and SSR ground stations 904B and 904C on its circumference 920. A second circle has a circumference 922, which includes the aircraft 902 and SSR ground stations 904A and 904B on its circumference 922. A third circle has a circumference 924, which includes the aircraft 902 and SSR ground stations 904A and 904C on its circumference 924. Once the centers and radii of the three circles 920, 922, and 924 have been determined, the single point at which all three circles overlap can be mathematically calculated. This point is the location of the aircraft 902.

FIG. 9 shows an aircraft 902 on an unknown aircraft heading 996. The onboard system determines a relative bearing Θ_{A} to a first SSR ground station 904A and a relative bearing Θ_{B} to a second SSR ground station 904B. As described above, the system can determine relative bearings Θ_{A} and Θ_{B} using a TAS or TCAS directional antenna (not shown). The difference between the two relative bearings Θ_{B}-Θ_{A} (referred to herein as an “azimuth difference”) can also be calculated.

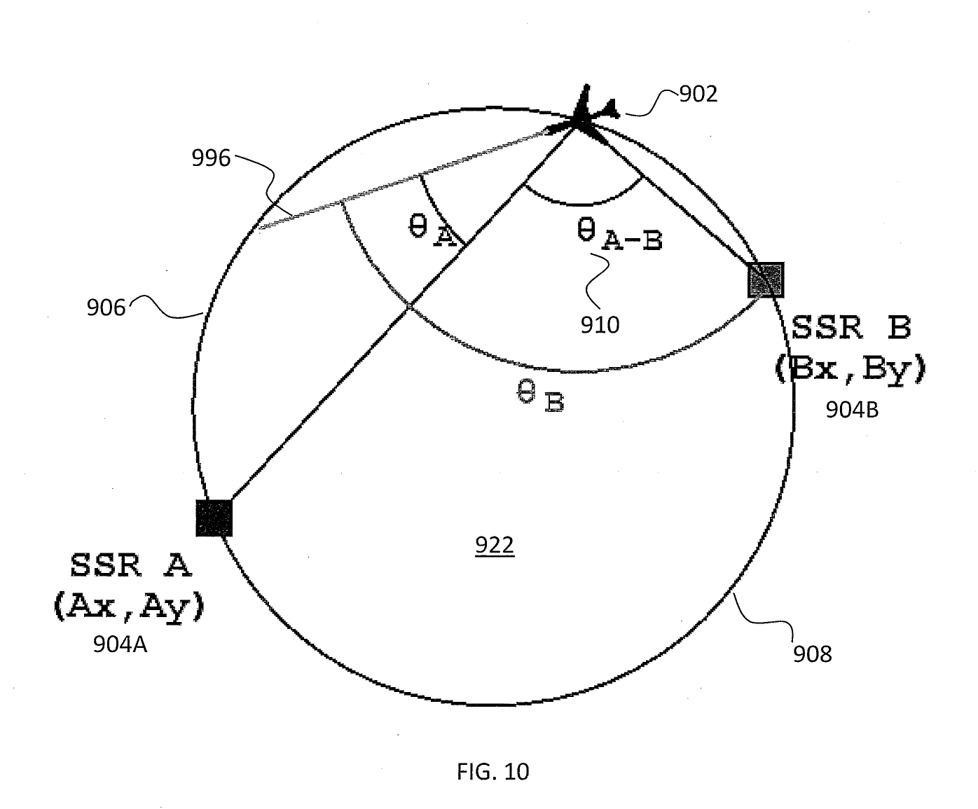

FIG. 10 shows the aircraft 902 with respect to SSR ground stations 904A,B. As described above, the SSR ground stations 904A,B broadcast their identity, which enables the invention system to look up their locations in a database. Alternatively, the SSR ground stations 904A,B also may broadcast their locations. The aircraft 902 therefore knows that SSR ground station 904A is located at a particular longitude (A_{X}) and latitude (A_{Y}) and that ground station 904B is located at a particular longitude (B_{X}) and latitude (B_{Y}). A single circle 922 can be drawn that passes through the two SSR ground stations 904A,B and also through the aircraft 902. One mathematical principle of circle 922 is that for the aircraft 902 located at any point on circular arc 906, the azimuth difference 910 is constant. The azimuth difference 910 may have a different constant value when the aircraft 902 is located at any point on circular arc 908. To simplify the calculations for determining the center point and radius of the circle 922, it is assumed that the aircraft is at a point on circular arc 906 that is equidistant from the two SSR ground stations 904A,B.

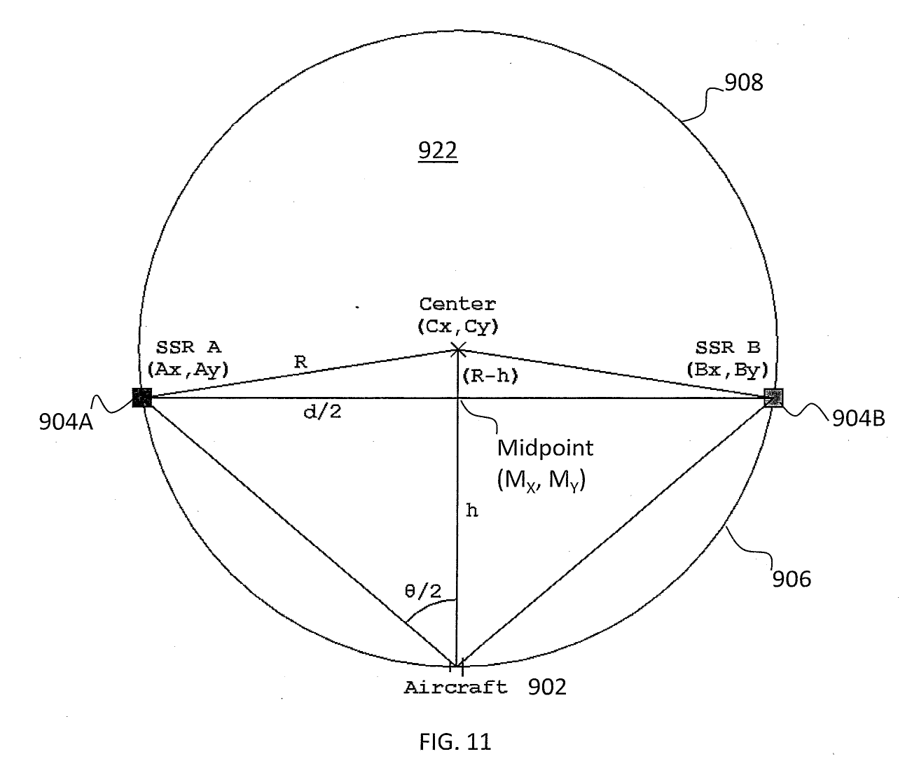

FIG. 11 shows the aircraft 902 positioned on circular arc 906 and equidistant from the two SSR ground stations 904A,B. SSR ground station A 904A is located at longitude A_{X} and latitude A_{Y} and SSR ground station B 904B is located at longitude B_{X} and latitude B_{Y}. As shown in FIG. 11, the angle Θ/2 is equal to half of the azimuth difference Θ_{B}-Θ_{A}. As described above, the distance d between the SSR ground stations 904A,B can be determined as:

d=\sqrt{Δlatitude²+Δlongitude²}=\sqrt{(A_{X}−B_{X})²+(A_{Y}−B_{Y})²}. (19)

The distance from the aircraft 902 to the line connecting the two SSR ground stations 904A,B (denoted “h”) can be determined as follows:

$$tan ( \frac{θ}{2} ) = \frac{\frac{d}{2}}{h} = \frac{d}{2 h} , \qquad ( 20 )$$

which can be rearranged as:

$$h = \frac{d}{2 tan ( \frac{θ}{2} )} . \qquad ( 21 )$$

The radius R of the circle can then be calculated as follows:

$$\begin{matrix}{R}^{2} = {( \frac{d}{2} )}^{2} + {( R - h )}^{2} \\ = {( \frac{d}{2} )}^{2} + {R}^{2} - Rh - Rh + {h}^{2} \\ = {( \frac{d}{2} )}^{2} + {R}^{2} - 2 Rh + {h}^{2} .\end{matrix} \qquad ( 22 )$$

Rearranging equation (22) and solving for R results in:

$$\begin{matrix}R = \frac{1}{2} ( \frac{{d}^{2}}{4 h} + h ) \\ = \frac{1}{2} ( \frac{{d}^{2}}{4 \frac{d}{2 tan ( \frac{θ}{2} )}} + \frac{d}{2 tan ( \frac{θ}{2} )} ) .\end{matrix} \qquad ( 23 )$$

Once the radius of the circle is determined, the location of the center (C_{X}, C_{Y}) of circle 922 can be determined. First, the midpoint (M_{X}, M_{Y}) of the line connecting the two SSR ground stations is determined as follows:

$${M}_{X} = {A}_{X} + \frac{{B}_{X} - {A}_{X}}{2} \qquad ( 24 )$$

and

$${M}_{Y} = {A}_{Y} + \frac{{B}_{Y} - {A}_{Y}}{2} . \qquad ( 25 )$$

The normal Θₙ to the line connecting the two SSR ground stations is as follows:

$${θ}_{n} = {tan}^{- 1} ( - \frac{{A}_{Y} - {B}_{Y}}{{A}_{X} - {B}_{X}} ) . \qquad ( 26 )$$

Now that the radius of the circle 922 is known and the midpoint and normal line are also know, the center point (C_{X} (longitude), C_{Y} (latitude)) of the circle can be determined as follows:

C_{X}=M_{X}+(R−h)sin(θₙ) (27)

and

C_{Y}=M_{Y}+(R−h)cos(θₙ). (28)

Now, the centerpoint (C_{X}, C_{Y}) and radius R of circle 922, which includes SSR ground stations 904A,B and aircraft 902 on it, are known. The above-described calculations are repeated to find centerpoints and radii for circles 920 and 924.

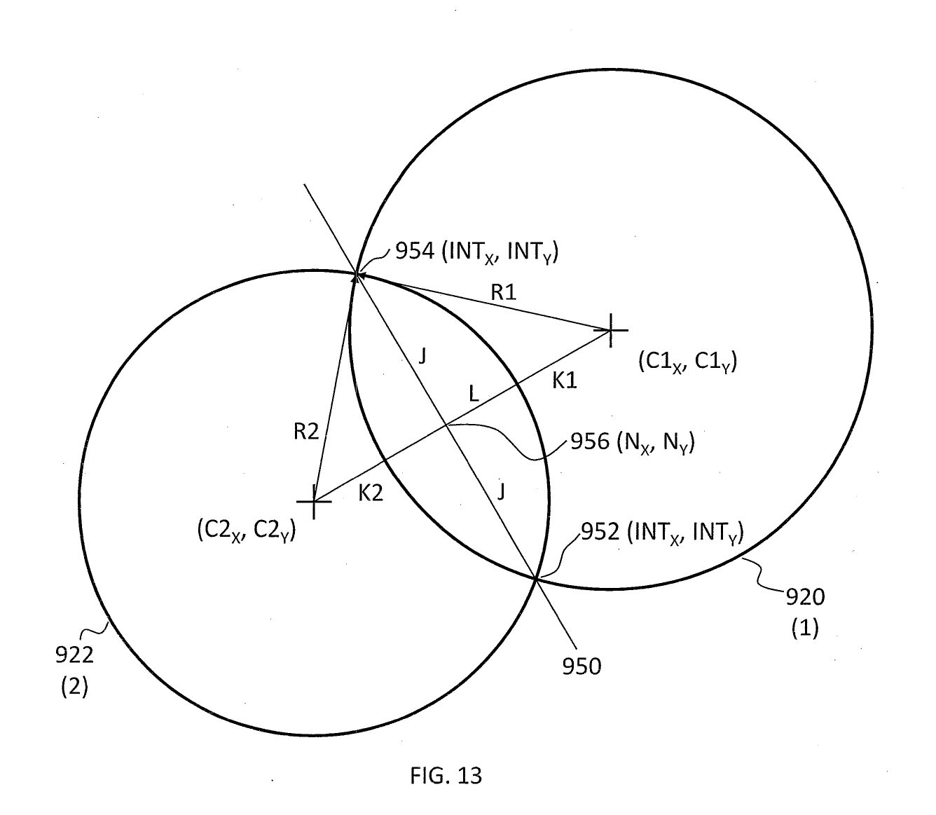

Once the radii and centerpoints for the three circles 920, 922, and 924 are calculated, the intersecting point of all three circles (where aircraft 902 is located) can be determined. The calculation of the intersection of two circles is well understood and is described in conjunction with FIG. 13. First, the distance L between the centerpoints (C1_{X}, C1_{Y}) and (C2_{X}, C2_{Y}) of circles 920 and 922, respectively, is determined as follows:

L=\sqrt{(C1_{X}−C2_{X})²+(C1_{Y}−C2_{Y})²}.(29)

Next, the distance K1 from centerpoint (C1_{X}, C1_{Y}) to a line 950 that connects the two points 952, 954 where circles 920 and 940 intersect is determined as described below. Alternatively, the distance K2 from centerpoint (C2_{X}, C2_{Y}) to the line 950 that connects the two points 952, 954 where circles 920 and 940 intersect can be determined in the same manner described below. The line 950 always will be perpendicular to the line L connecting centerpoints (C1_{X}, C1_{Y}) and (C2_{X}, C2_{Y}) of circles 920 and 922, respectively. Therefore, the Pythagorean equation applies such that:

K1²+J²=R1² (30)

and

K2²+J²=R2². (31)

Equations (30) and (31) can be combined as:

R1²−K1²=R2²−K2². (32)

Knowing that

L=K1+K2, (33)

equation (32) can be rearranged to solve for K1 as

$$K 1 = \frac{R {1}^{2} - R {2}^{2} + {L}^{2}}{2 L} . \qquad ( 34 )$$

K2 can be determined according to equation (33) because L and K1 are now known. The location (N_{X}, N_{Y}) 956 of the intersection of the line between the centerpoints (C1_{X}, C1_{Y}) and (C2_{X}, C2_{Y}) of circles 920 and 922, respectively, and the line 950 that connects the two points 952, 954 where circles 920 and 940 intersect can now be determined as follows:

$$\begin{matrix}{N}_{X} = C {1}_{X} + \frac{K 1 \cdot ( C {2}_{X} - C {1}_{X} )}{L} and & ( 35 ) \\ {N}_{Y} = C {1}_{Y} + \frac{K 1 \cdot ( C {2}_{Y} - C {1}_{Y} )}{L} . & ( 36 )\end{matrix}$$

Also, the distance J from the (N_{X}, N_{Y}) 956 to intersections 952, 954 can be determined according to equation (26) in rearranged form as:

J=\sqrt{R1²−K1²}. (37)

The coordinates (INT_{X}, INT_{Y}) of intersection points 952, 954 can be calculated as follows:

$$\begin{matrix}{INT}_{X} = {N}_{X} \pm \frac{J \cdot ( C {2}_{Y} - C {1}_{Y} )}{L} and & ( 38 ) \\ {INT}_{Y} = {N}_{Y} \pm \frac{J \cdot ( C {2}_{X} - C {1}_{X} )}{L} . & ( 39 )\end{matrix}$$

The aircraft 902 is located at one of the two calculated intersection points 952, 954. However, one of the SSR ground stations also is located at one of the two intersection points 952, 954. In the example calculation described above and in conjunction with FIG. 13, circles 920 and 922 share SSR ground station 904B. The invention system knows the location (B_{X}, B_{Y}) of SSR ground station 904B. The system therefore can assume that whichever intersection point 952, 954 is closest to the location (B_{X}, B_{Y}) of SSR ground station 904B. The system also can assume that the aircraft 902 is located at the remaining intersection point. For example, if the system determines that the known location (B_{X}, B_{Y}) of SSR ground station 904B is closest to intersection point 952, then it knows that the aircraft is at intersection point 954. It is possible to merely perform the circle intersection calculations described above for one pair of the three circles 920, 922, 924. However, performing the circle intersection calculations for each pair of the three circles 920, 922, 924 may be beneficial. It is possible that performing the above-described circle intersection calculations for each pair of the three circles 920, 922, 924 may yield a slightly different location of the aircraft 902 for reasons such as numerical rounding and measurement error. Calculating the circle intersections and determining aircraft location for each possible pairing of the circles 920, 922, 924 may provide for error checking because the three resulting aircraft locations may be compared. Also, the three resulting aircraft locations 902 may be averaged and the averaged aircraft location 902 may be used as the current aircraft location.

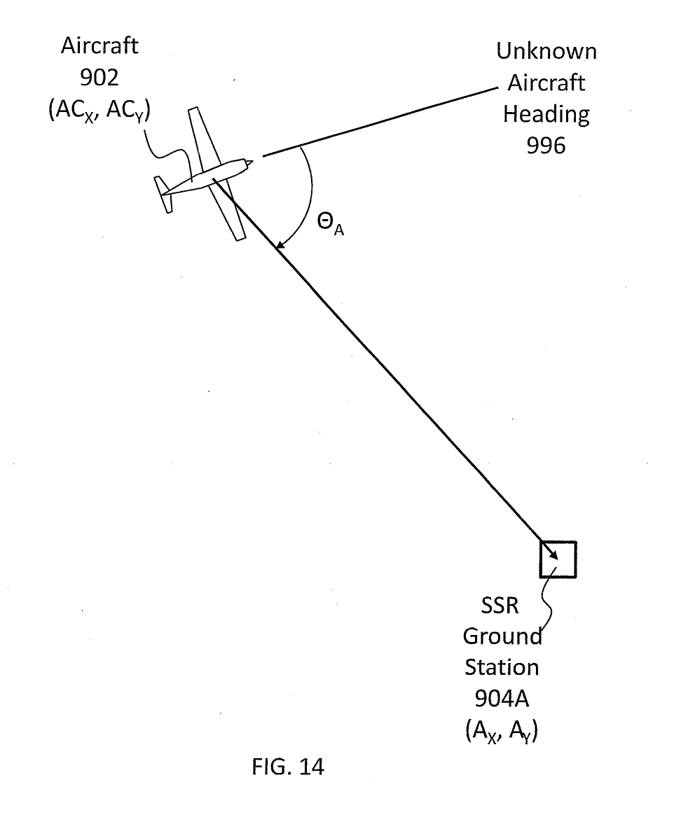

Once the aircraft location 902 (AC_{X}, AC_{Y}) is determined, as described above in FIGS. 9-13, the aircraft's true heading can be determined. FIG. 14 shows the aircraft 902 on an unknown heading 996, but an aircraft location 902 (AC_{X}, AC_{Y}) is known and a relative bearing Θ_{A} from the unknown aircraft heading 996 to SSR ground station 904A is known. A true bearing to SSR ground station 904A from the aircraft location 902 can be determined. Then, the relative bearing Θ_{A} can be added (or subtracted, whichever is proper) to the relative bearing to determine the aircraft's true heading. For example, if the true bearing to SSR ground station 904A is a compass direction of 150° and relative bearing Θ_{A} is 75°, then the aircraft heading is 75° (150°−75°=75°). The mathematics for calculating actual aircraft heading is as follows:

$${AC}_{Heading} = {tan}^{- 1} ( \frac{{A}_{Y} - {AC}_{Y}}{{A}_{X} - {AC}_{X}} ) - {θ}_{A} . \qquad ( 40 )$$

The aircraft's true heading may be determined with respect to SSR ground stations 904B and 904C in the same manner.

Thus embodiments of the invention provide a backup position source for GPS in areas with UAT coverage. Since such systems 300, 800 utilize existing UAT receivers, it reduces the cost of a backup position source installation.

Given the foregoing, what has been described above are two ways of determining an aircraft position. In a first way, a set of possible positions is determined by calculating distances to two UAT ground stations (as described above in conjunction with FIG. 1). Determining a position from the set of possible positions at which the aircraft is located can be accomplished by calculating the distance to a third UAT station (as described above in conjunction with FIG. 2), or by other means such as dead reckoning or information from other navigation instruments, like VOR or ADF bearings. In a second way, a set of possible positions is determined by calculating relative bearings to two SSR ground stations. Here, the set of possible positions includes all points on a circular arc that passes through the two SSR ground stations (as described above in conjunction with FIG. 10). Determining the position from the set of possible positions at which the aircraft is located can be accomplished by several means. If the aircraft's heading is known, then the relative bearings to the SSR ground stations can be converted to true bearings. The true bearings limit the aircraft to a position on the circular arc (as described above in conjunction with FIGS. 5-8). If the aircraft's heading is not known, then determining a relative bearing to a third SSR ground station enables the determination of three sets of possible positions at which the aircraft is located—one set for each of the three possible pairings of the SSR ground stations (as described above in conjunction with FIGS. 11-13). Each of the three sets of possible positions is a circular arc, and the three circular arcs intersect. The position where the three circular arcs intersect is the position of the aircraft. The aircraft's position on the circular arc of possible positions also may be determined through dead reckoning or information from other navigation instruments, like VOR or ADF bearings.

As used herein, “a position” or “the position” of the aircraft may refer to a single determined position at which the aircraft may be located or a range of positions at which the aircraft may be located.

While this invention has been particularly shown and described with references to example embodiments thereof, it will be understood by those skilled in the art that various changes in form, formulation, and details may be made therein without departing from the scope of the invention encompassed by the appended claims.

What is claimed is:

1. A computer system for determining aircraft position comprising:
a clock onboard an aircraft;
an antenna onboard the aircraft configured to receive UAT ground station transmissions;
a database containing locations of UAT ground stations; and
a computer processor onboard the aircraft, in communication with the clock, the antenna, and the database, the computer processor configured to:
receive transmissions from at least two UAT ground stations;
identify each of the at least two UAT ground stations based on information from the UAT ground station transmissions;
extract from the database locations of each of the at least two UAT ground stations;
compare timing signals from each of the at least two UAT ground stations to determine a distance of the aircraft from each of the at least two UAT ground stations; and
determine at least one location at which the aircraft is at the determined distance from each of the at least two UAT ground stations.

2. The system of claim 1 wherein the computer processor outputs the determined at least one aircraft location to an ADS-B system of the aircraft.

3. The system of claim 1 wherein the computer processor identifies at least three UAT ground stations; and
wherein the computer processor determines a single location at which the aircraft is at the determined distanced from each of the at least three UAT ground stations.

4. The system of claim 1 wherein the computer processor is further configured to use dead reckoning from a previous known position of the aircraft to determine a single aircraft location from the at least one location at which the aircraft is at the determined distance from each of the at least two UAT ground stations.

5. The system of claim 1 further comprising at least one of a VOR receiver and an ADF receiver; and
wherein the computer processor is further configured to use at least one of VOR and ADF signals to determine a single aircraft location from the at least one location at which the aircraft is at the determined distance from each of the at least two UAT ground stations.

6. A computer-implemented method for determining an aircraft position comprising:
receiving at least two UAT ground station transmissions, each UAT ground station transmission including a timing signal;
comparing each received timing signal to an onboard timing signal to determine a distance to each UAT ground station; and
based on known locations of each UAT ground station, determining at least one aircraft location at which the aircraft is at the determined distance from each of the at least two UAT ground stations.

7. The computer-implemented method of claim 6 further comprising outputting the determined at least one aircraft location to an ADS-B system.

8. The computer-implemented method of claim 6 wherein receiving at least two UAT ground station transmissions comprises receiving at least three UAT ground station transmissions; and
determining a single location at which the aircraft is at the determined distanced from each of the at least three UAT ground stations.

9. The computer-implemented method of claim 6 further comprising dead reckoning from a previous known position of the aircraft to determine a single aircraft location from the at least one location at which the aircraft is at the determined distance from each of the at least two UAT ground stations.

10. The computer-implemented method of claim 1 further comprising using at least one of VOR and ADF signals to determine a single aircraft location from the at least one location at which the aircraft is at the determined distance from each of the at least two UAT ground stations.

11. A computer system for determining aircraft position comprising:
a compass onboard an aircraft;
a directional antenna onboard the aircraft configured to receive SSR ground station transmissions;
a database containing locations of SSR ground stations; and
a computer processor onboard the aircraft, in communication with the compass, the directional antenna, and the database, the computer processor configured to:
receive transmissions from at least two SSR ground stations;
identify each of the at least two SSR ground stations based on information from the SSR ground station transmissions;
extract from the database locations of each of the at least two SSR ground stations;
determine a true bearing to each of the at least two SSR ground stations; and
determine at least one location at which the aircraft is at the determined bearing to each of the at least two SSR ground stations.

12. The system of claim 11 wherein the computer processor outputs the determined at least one aircraft location to an ADS-B system of the aircraft.

13. The system of claim 11 wherein the computer processor is further configured to use dead reckoning from a previous known position of the aircraft to determine a single aircraft location from the at least one location at which the aircraft is at the determined distance from each of the at least two SSR ground stations.

14. The system of claim 11 further comprising at least one of a VOR receiver and an ADF receiver; and
wherein the computer processor is further configured to use at least one of VOR and ADF signals to determine a single aircraft location from the at least one location at which the aircraft is at the determined distance from each of the at least two SSR ground stations.

15. A computer-implemented method for determining an aircraft position comprising:
receiving at least two SSR ground station transmissions;
determining a true bearing to each of the at least two SSR ground stations; and
based on known locations of each SSR ground station, determining at least one aircraft location at which the aircraft is at the determined distance from each of the at least two SSR ground stations.

16. The computer-implemented method of claim 15 further comprising outputting the determined at least one aircraft location to an ADS-B system of the aircraft.

17. The computer-implemented method of claim 15 further comprising using dead reckoning from a previous known position of the aircraft to determine a single aircraft location from the at least one location at which the aircraft is at the determined distance from each of the at least two SSR ground stations.

18. The method of claim 15 further comprising using at least one of VOR and ADF signals to determine a single aircraft location from the at least one location at which the aircraft is at the determined distance from each of the at least two SSR ground stations.

19. A computer-implemented method for determining an aircraft position, comprising:
receiving at least three SSR ground station transmissions;
determining locations of the at least three SSR ground stations;
determining relative bearings from the aircraft to each of the respective at least three SSR ground stations;
determining a size and location of a first circle that includes on its circumference the aircraft and a first SSR ground station and a second SSR ground station of the at least three SSR ground stations;
determining a size and location of a second circle that includes on its circumference the aircraft and the first SSR ground station and a third SSR ground station of the at least three SSR ground stations; and
determining a first intersection of the circumferences of the first and second determined circles as a location at which the aircraft is located.

20. The computer-implemented method of claim 19 wherein determining an intersection of the circumferences of the first and second determined circles at which the aircraft is located includes determining two intersection points and selecting as the location of the aircraft one of the two intersection points located farthest from the first SSR ground station.

21. The computer-implemented method of claim 19 further comprising determining a size and location of a third circle that includes on its circumference the aircraft and the second SSR ground station and the third SSR ground station of the at least three SSR ground stations;
determining a second intersection of the circumferences of the first and third determined circles as a location at which the aircraft is located;
determining a third intersection of the circumferences of the second and third determined circles as a location at which the aircraft is located; and
calculating as the location of the aircraft an average of the first, second, and third intersections.

22. The computer-implemented method of claim 19 further comprising determining a true bearing from the location at which the aircraft is located to one of the at least three SSR ground stations; and
calculating the aircraft heading by comparing the determined true bearing to the relative bearing to the one SSR ground station.

23. A computer system for determining aircraft position, comprising:
a directional antenna onboard the aircraft configured to receive SSR ground station transmissions;
a computer processor onboard the aircraft, in communication with the directional antenna, configured to:
receive transmissions from at least three SSR ground stations;
identify each of the at least three SSR ground stations based on information from the SSR ground station transmissions;
determine locations of the respective SSR ground stations;
determine a relative bearing to each of the at least three SSR ground stations;
determine a size and location of a first circle that includes on its circumference the aircraft and a first SSR ground station and a second SSR ground station of the at least three SSR ground stations;
determine a size and location of a second circle that includes on its circumference the aircraft and the first SSR ground station and a third SSR ground station of the at least three SSR ground stations; and
determine a first intersection of the circumferences of the first and second determined circles as a location at which the aircraft is located.

24. The computer system of claim 23 further including a database onboard the aircraft that includes locations of SSR ground stations; and
wherein the computer processor determines locations of the respective SSR ground stations by associating each of the at least three identified SSR ground stations with a location in the database.

25. The computer system of claim 23 wherein each SSR ground station transmission includes a location of the SSR ground station; and
wherein the computer processor determines locations of the respective SSR ground stations by extracting the location from the SSR ground station transmissions.

26. The computer system of claim 23 wherein the computer processor is further configured to:
determine a size and location of a third circle that includes on its circumference the aircraft and the second SSR ground station and a third SSR ground station of the at least three SSR ground stations; and
determine a second intersection of the circumferences of the first and third determined circles as a location at which the aircraft is located;
determine a third intersection of the circumferences of the second and third determined circles as a location at which the aircraft is located; and
calculate as the location of the aircraft an average of the first, second, and third intersections.

27. The computer system of claim 23 wherein the computer processor is further configured to:
determine a true bearing from the location at which the aircraft is located to one of the at least three SSR ground stations; and
calculate the aircraft heading by comparing the determined true bearing to the relative bearing to the SSR ground station.

28. A computer-implemented method for determining an aircraft position comprising:
in an aircraft, receiving transmissions from two SSR ground stations;
determining a relative bearing to each of the two SSR ground stations;
based on known locations of the two SSR ground stations and the relative bearings to each station, determining a set of possible positions of the aircraft; and
identifying a position from the set of possible positions at which the aircraft is located.

29. The computer-implemented method of claim 28 wherein identifying a position from the set of positions at which the aircraft is located comprises:
determining a true bearing to each of the two SRR ground stations; and
determining a position from the set of positions closest to an intersection of lines defined by the true bearings to each of the two SSR ground stations as the position of the aircraft.

30. The computer-implemented method of claim 28 wherein identifying a position from the set of positions at which the aircraft is located comprises identifying a position closest to a dead reckoning position of the aircraft.

31. The computer-implemented method of claim 28 wherein the set of possible positions is a first set, and wherein identifying a position from the set of positions at which the aircraft is located comprises:
receiving a transmission from a third SSR ground station;
determining a location of the third SSR ground station;
determining a relative bearing to the third SSR ground station;
based on the known locations of the first SSR ground station and the third SSR ground station, and based on the relative bearings to the first and third SSR ground stations, determining a second set of possible positions at which the aircraft may be located;
identifying a position from the first set of positions that is most proximate to a position from the second set of positions; and
identifying as the position of the aircraft a position based on the position from at least one of the first set of positions and the position from the second set of positions.

32. The computer-implemented method of claim 31 wherein identifying as the position of the aircraft a position based on the position from at least one of the first set of positions and the position from the second set of positions comprises identifying the position from the first set of positions as the position of the aircraft.

33. The computer-implemented method of claim 31 wherein identifying as the position of the aircraft a position based on the position from at least one of the first set of positions and the position from the second set of positions comprises identifying the position from the second set of positions as the position of the aircraft.

34. The computer-implemented method of claim 31 wherein identifying as the position of the aircraft a position based on the position from at least one of the first set of positions and the position from the second set of positions comprises identifying an average position between the position from the first set of positions and the second set of positions as the position of the aircraft.

35. The computer-implemented method of claim 28 wherein identifying a position from the set of positions at which the aircraft is located comprises identifying a position closest at least one of a VOR reading and an ADF reading.
